(19) United States
(12) Patent Application Publication
(10) Pub. No.: US 2008/0191676 A1
(43) Pub. Date: Aug. 14, 2008

(54) Arrangement for Smoothing the Load Current Supplied to a Load

(75) Inventor: Reinhard Ritschel, Waldkraiburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rohde & Schwarz GmbH & Co. KG, Munchen (DE)

(21) Appl. No.: 11/814,555

(22) PCT Filed: Jan. 16, 2006
(86) PCT No.: PCT/EP2006/000334

§ 371 Date: Sep. 27, 2007

(30) Foreign Application Priority Data
Jan. 26, 2005 (DE) 102005003686.4

(51) Int. Cl. G05F 1/08

(52) U.S. Cl. 323/282

(57) ABSTRACT

The invention relates to smoothing a consumer electrical circuit supplied by a controllable current sink connected in parallel to the consumer. For this purpose, measuring voltage proportional to a load current supplied to the consumer is derived therefrom. A pick value measuring device makes it possible to determine a maximum value thereof. The difference between the maximum value and measuring voltage makes it possible to control the voltage-controlled current sink in such a way that the sum of a compensation current supplied by the current sink and the load current which runs by the consumer is substantially constant.

The invention relates to an arrangement according to the preamble of claim 1.

In the case of electronic devices with circuits with a strongly-fluctuating current consumption, it is often necessary to smooth the load current supplied from a direct-current source. However, the use of conventional LC filters with large smoothing condensers is often precluded because of lack of space. It is, in fact, already known that, in order to smooth a pulsating direct-current supply, a controllable current sink can be connected in parallel to the load, and the total input current resulting from the sum of the load current and the compensation current can be measured and compared with a specified set value and, dependent upon the latter, the compensation current can be regulated via the current sink in such a manner that the supply current remains substantially constant. However, this known regulating circuit is relatively complex and often not fast enough; it is unstable and tends to oscillate.

The object of the invention is therefore to provide an arrangement for smoothing the load current supplied to a load, which avoids the disadvantages of compensation-current regulation in spite of its small space requirement.

This object is achieved on the basis of an arrangement according to the preamble of claim 1 by its characterising features. Advantageous further developments are specified in the dependent claims.

With the arrangement according to the invention, the compensation current generated by the current sink is not obtained by regulation but by control. An arrangement of this kind is therefore very fast and stable and automatically adapts even to relatively rapid changes in load current.

The invention is explained in greater detail below on the basis of an exemplary embodiment with reference to a schematic circuit diagram. The drawings are as follows:

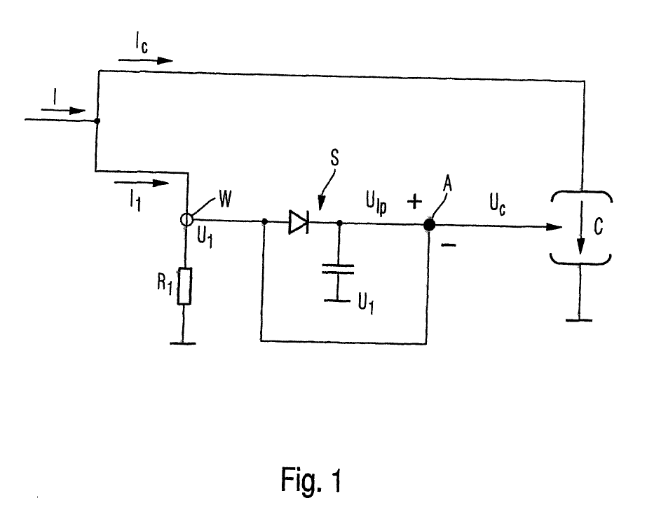

FIG. 1 shows a schematic circuit diagram of an exemplary embodiment of the arrangement according to the invention.

The drawing shows an arrangement according to the invention for smoothing the direct load current I supplied to a load R₁ by means of a controllable current sink C connected in parallel to the load R₁.

This voltage-controlled current sink C is, in principle, a controlled load. In modern circuit technology, it is preferably realised by controllable transistors combined with corresponding resistors. The total load current I, which is supplied to the load RI from a direct-current source, which is not illustrated, is composed of the sum of the load current I₁ supplied to the load R₁ and the compensation current I_{c} flowing through the current sink C. The load current I₁ is converted into a proportional measured voltage U₁ by means of a current/voltage converter W. The converter W is, for example, a shunt arranged in the load-current circuit.

The maximum value U₁ₚ of the measured voltage U₁ is determined by means of a peak detector S, and the difference between the maximum value U₁ₚ and the momentary value U₁ is determined in a voltage adder A. The result U_{c} controls the compensation current I_{c} in the current sink C in such a manner that the load current I=I₁+I_{c} is substantially constant and fluctuates only slightly.

The filter effect of the arrangement according to the invention is determined by the accuracy of the measurement of the load current I₁ and the accuracy of control of the current sink C. The response time and discharge time of the peak detector S, as well as the mean value for the maximum value of the measured voltage obtained through this peak detector and the derivative action of the momentary value U₁ of the measured voltage proportional to the load current are dimensioned in such a manner that, for a specified load-current characteristic I₁, an optimum is obtained with regard to the filter effect and power loss in the current sink C.

By preference, a switching device, which is not illustrated, but through which the compensation current I_{c} is switched on and off together with the load R₁, is also allocated to the current-compensation circuit. Moreover, the peak-compensation current I_{c} is specified by a corresponding limitation of the maximum value U₁ₚ determined in the peak detector. For this purpose, a corresponding voltage limiter is connected, for example, in parallel to the charging condenser of the peak detector S.

Furthermore, it is advantageous to limit the mean value of the compensation current I_{c} and to monitor the temperature of the current sink C and, dependent upon the latter, to limit the maximum value U₁ₚ, so that the filter effect is correspondingly limited and weakened in the event of an overload.

The invention is not restricted to the exemplary embodiment presented. All of the elements described and illustrated can be combined with one another as required.

1. Device for smoothing a load current supplied to a load by a controllable current sink connected in parallel to the load,
wherein
a measured voltage proportional to the load current is derived from the load current supplied to the load; its maximum value is determined by means of a (S); and the voltage-controlled current sink is controlled with the difference between the maximum value and the measured voltage in such a manner that the sum of the compensation current flowing through the current sink and the load current flowing through the load is substantially constant.

2. Arrangement according to claim 1,
wherein
the measured voltage proportional to the load current is measured in a shunt resistor arranged in the load-current circuit, and the maximum value of this measured voltage is measured by means of a peak detector.

3. Arrangement according to claim 1,
wherein
the maximum value of the measured voltage is limited to a predetermined value.

4. Arrangement according to claim 3,
wherein
the mean value of the compensation current of the current sink is determined, and the limitation of the maximum value is determined dependent upon the latter.

5. Arrangement according to claim 3,
wherein
the temperature of the current sink is determined, and the limitation of the maximum value is determined dependent upon the latter.

6. Arrangement according to claim 1, wherein
the arrangement can be switched on and off together with the load by a switching device.
